(19) United States
(12) Patent Application Publication
(10) Pub. No.: US 2016/0025220 A1
(43) Pub. Date: Jan. 28, 2016

(54) Actuation Rod Lubrication System And Method

(71) Applicant: SPX Corporation, Charlotte, NC (US)

(72) Inventors: James E. Cooper, Menomonee Falls, WI (US); Bruce K. Knuth, Oconomowoc, WI (US)

(21) Appl. No.: 14/805,148

(22) Filed: Jul. 21, 2015

Related U.S. Application Data
(60) Provisional application No. 62/027,350, filed on Jul. 22, 2014.

(51) Int. Cl. F16J 10/02

(52) U.S. Cl. CPC F16J 10/02

(57) ABSTRACT

A cylinder retainer is provided. The cylinder includes: a retainer body having an exterior end and an interior end; a bearing surface located on the retainer body; and an oiler located in a recess in the retainer body. A method of lubricating a rod may be provided. The method may include: contacting an oiler with the rod; and locating a bearing surface on a cylinder retainer between a seal configured to keep fluid located on a surface of the rod in a cylinder and the oiler.

This application claims the benefit of a provisional U.S. patent application entitled Actuation Rod Lubrication System And Method, having a Ser. No. 62/027,350, filed Jul. 22, 2014. The disclosure of this application is hereby incorporated by reference in its entirety.

### FIELD OF THE INVENTION

The present invention relates generally to hydraulic cylinders. More particularly, the present invention relates to lubricating the rod in a hydraulic cylinder.

### BACKGROUND OF THE INVENTION

Many hydraulic cylinders involve an internal piston that is moved back and forth along the length of the cylinder. A actuation rod is often attached to the cylinder and the rod moves in and out of the cylinder as the piston moves. The actuation rod is often connected to structure outside of the cylinder that moves when the rod moves. Often, a wiper is located near the end of the piston into which the rod enters. The wiper is used to clean the rod of dirt, debris, and any foreign matter before the rod enters the hydraulic cylinder.

Inside of the hydraulic cylinder is a seal that is often used to seal against the rod and prevent hydraulic fluid from the hydraulic cylinder from moving out the hydraulic cylinder along with the rod. However, a drawback of the seal is that the rod is dried once it moves past the seal and therefore is not lubricated as the rod moves past or rubs the structure of the hydraulic cylinder as it moves in and out of the cylinder.

A lack of lubrication along the rod, as it moves past the structure of the hydraulic cylinder, can create wear on the surface of the rod. This wear problem can be exacerbated when the rod is subject to side loads. Side loads may occur where forces acting on the rod in a direction not axial with the rod. These side loads can cause the rod to rub against the structure of the hydraulic cylinder as the rod moves in and out of the hydraulic cylinder.

Accordingly, it is desirable to provide a method and apparatus that provides lubrication for the rod.

### SUMMARY OF THE INVENTION

The foregoing needs are met, to a great extent, by the present invention, wherein in one aspect, in some embodiments, a method and/or an apparatus is provided that provides lubrication for the rod in a location such that the rod is lubricated along the bearing surface of the retainer and neither the seal nor the wiper removes the lubrication from the rod at the location along the bearing surface.

In accordance with one embodiment of the present invention, a hydraulic cylinder retainer is provided. The hydraulic cylinder includes: a retainer body having an exterior end and an interior end; a bearing surface located on the retainer body; and an oiler located in a recess in the retainer body.

In accordance with another embodiment of the present invention, a method of lubricating a rod may be provided. The method may include: contacting an oiler with the rod; and locating a bearing surface on a hydraulic cylinder retainer between a seal configured to keep hydraulic fluid located on a surface of the rod in a hydraulic cylinder and the oiler.

In accordance with yet another embodiment of the present invention, a hydraulic cylinder retainer may be provided. The hydraulic cylinder retainer may include: a retainer body having an exterior end and an interior end; a bearing surface located on the retainer body; and a means for lubricating located in a recess in the retainer body.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. While this disclosure has primarily discusses hydraulic cylinders, one of ordinary skill the art after reviewing this disclosure will understand that various principles of this disclosure may be applied to a variety of cylinders. For example, pneumatic cylinders, gas filled cylinders, liquid filled cylinders, or any other fluid filled cylinders that move a piston may be used in accordance with the disclosure herein. The principles described herein are not limited to hydraulic cylinders only that they are primarily discussed herein as an example.

The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 is a cross-sectional view illustrating a hydraulic cylinder, piston, and rod where the piston is in a first position.

FIG. 2 is a cross-sectional view illustrating a hydraulic cylinder, piston, and rod where the piston is in a second position.

FIG. 3 is a partial cross-sectional view of a hydraulic piston retainer in accordance with an embodiment in accordance with the disclosure.

FIG. 4 is a partial cross-sectional view of a hydraulic piston retainer, and associated components in accordance with the disclosure.

FIG. 5 is a partial cross-sectional view of a hydraulic piston retainer, and associated components in accordance with an embodiment having a second oiler in accordance with the disclosure.

### DETAILED DESCRIPTION

The invention will now be described with reference to the drawing figures, in which like reference numerals refer to like parts throughout. An embodiment in accordance with the present invention provides lubrication to a rod when the rod is urging against a bearing surface. In some embodiments, the lubrication system is configured so that neither the seal nor the wiper removes lubrication from the rod before the rod urges against the bearing surface of a retainer.

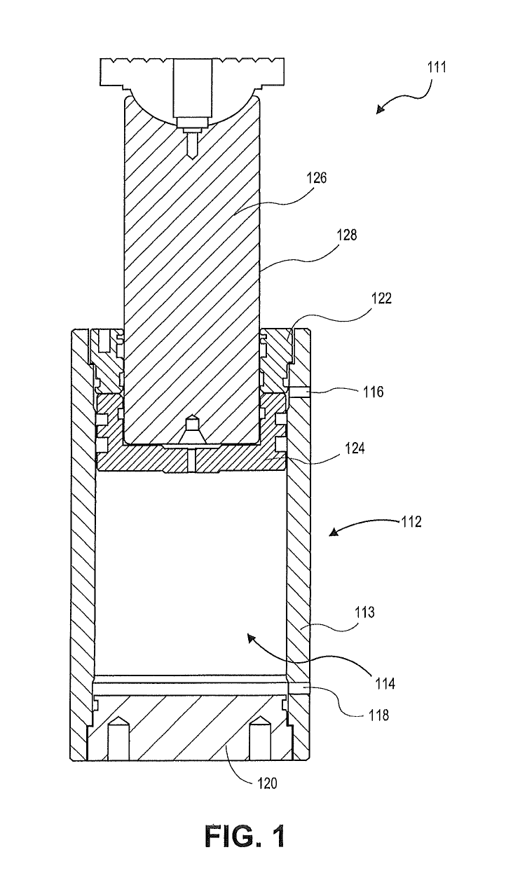

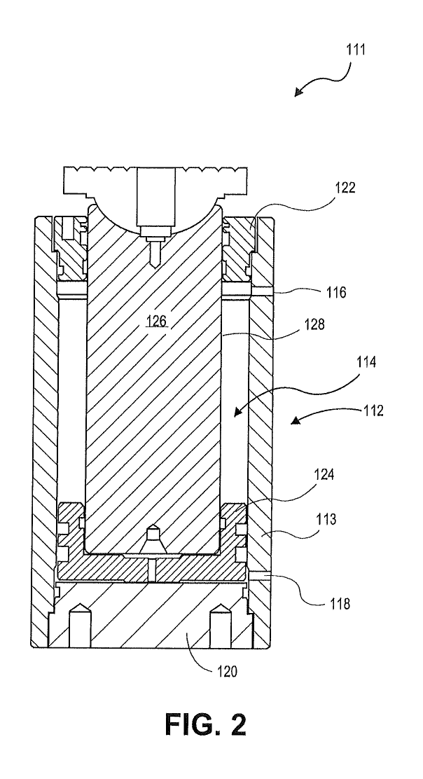

An embodiment of the present inventive apparatus is illustrated in FIGS. 1 and 2. FIGS. 1 and 2 illustrate a cross-sectional view of a hydraulic cylinder assembly 111. The hydraulic cylinder assembly 111 includes a hydraulic cylinder 112 having a housing 113. The hydraulic cylinder housing 113 defines an interior space 114. The hydraulic cylinder 112 contains a plug 120 and a retainer 122 to define a substantially fluid tight interior 114. The retainer 122 need not be a separate piece from the cylinder 112, but may be part of the cylinder 112 or housing 113 or some other feature. A first port 116 and a second port 118 provide inlet/outlets for hydraulic fluid to enter or leave the interior 114 of the hydraulic cylinder 112.

When hydraulic fluid enters the second port 118 and exits the first port 116, the piston 124 is pushed upward as shown in FIG. 1. This causes the rod or shaft 126 to move out of the hydraulic cylinder 112. When hydraulic fluid enters the first port 116 and exits the second port 118, the piston is pushed downward as shown in FIG. 2. This causes the rod or shaft 126 to move into the hydraulic cylinder 112.

As the rod or shaft 126 moves in and out of the hydraulic cylinder 112, the rod 126 slides against the retainer 122. Often, the rod 126 is subjected to side loads or, in other words, loads that are not in line with the longitudinal axis of the rod 126. Side loads cause the rod 126 to urge against the retainer 122. Wear of the surface 128 of the rod 126 against the retainer 122 can cause damage to the surface 128 of the rod 126 and/or retainer 122. In order to reduce this wear, various embodiments in accordance with the present disclosure provide a method and system for lubricating the surface 128 of the rod 126.

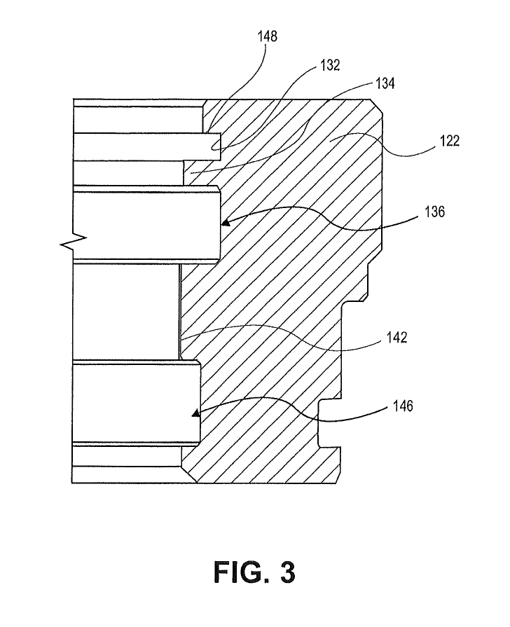

In some embodiments in accordance with the disclosure, a lubrication system is located in the retainer 122 to lubricate the surface 128 of the rod 126. FIG. 3 is a partial cross-sectional view of the retainer 122. One of ordinary skill in the art will understand that the retainer 122 is generally annular in shape. However, only a partial cross-sectional view is present in FIG. 3. The cross-sectional view shown in FIGS. 1 and 2 will communicate to one of ordinary skill in the art after reviewing this disclosure the annular shape of the retainer 122.

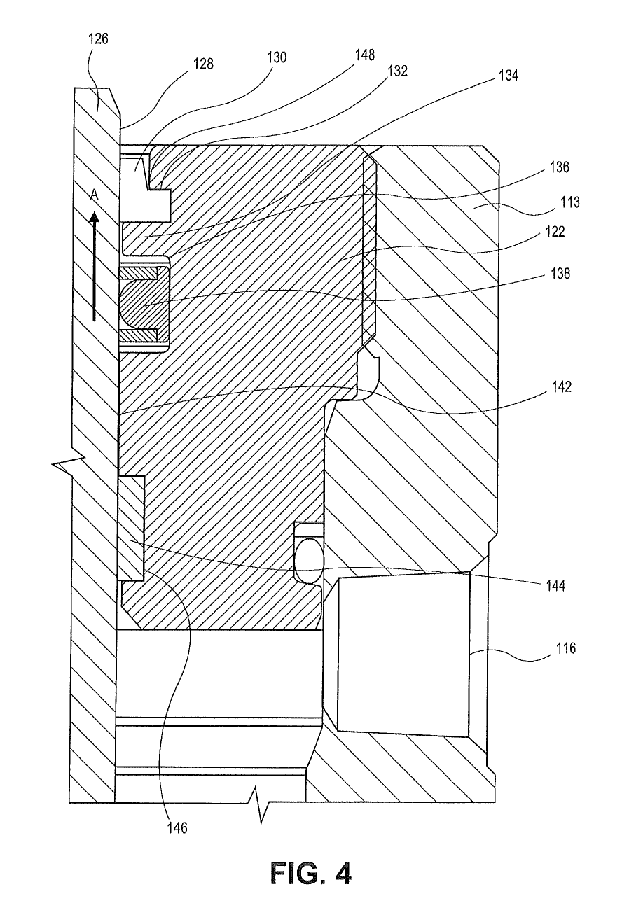

Returning to FIG. 3, a wiper recess 132 is illustrated in the retainer 122. The wiper recess 132 is located just above a retaining lip 134. The retaining lip 134 provides structure in the retainer 122 to retain a seal 138 (as shown in FIG. 4) in place. FIG. 3 illustrates a recess 136 located in the retainer 122 into which the seal 138 (as shown in FIG. 4) resides. The retainer 122 includes a bearing surface 142. It is the bearing surface 142 which contacts and rubs against the surface 128 of the rod or shaft 126 (not shown in FIG. 3).

In some embodiments, in accordance with the present disclosure, the rod 126 does not rub against any other portion of the retainer 122 then the bearing surface 142.

As shown in FIG. 3, the bearing surface 142 and the retainer 122 define a cutout or groove 146. It is in the cutout or groove 146 that a lubrication system resides for lubricating the surface 128 of the rod 126.

FIG. 4 is a partial cross-sectional view of the retainer 122 along with other components set with in the retainer 122. In addition, the retainer 122 is shown placed in the hydraulic cylinder 112. The housing 113 is shown as well as in the rod 126. The surface 128 of the rod 126 is shown to be adjacent to the bearing surface 142 of the retainer 122.

A wiper 130 is illustrated in the wiper recess 132 of the retainer 122. The wiper 130 provides the function of cleaning off any dirt, debris, or any other foreign matter from the surface 128 of the rod 126 as the rod 126 enters the hydraulic cylinder 112. As shown in FIG. 4, the wiper 130 may have a step shape, thus providing a stepped portion 148 of the wiper recess 132.

The retainer lip 134 can be seen as located below the wiper 130. The retainer lip 134 provides structure within the retainer 122 to prevent the seal 138 from being forced out of the hydraulic cylinder 112 due to hydraulic pressure within the interior 114 of the hydraulic cylinder 112 or due to friction from the rod 126 moving out of the hydraulic cylinder 112.

The seal 138 resides in the seal recess 136 within the retainer 122. The seal 138 prevents hydraulic fluid from moving along the surface 128 of the rod 126 to exit the hydraulic cylinder 112. The seal 138 and the wiper 130 may be relatively well-known in the art and do not merit further discussion herein.

FIG. 4 also illustrates a lubrication system 144. In some embodiments, the lubrication system 144 simply consists of felt impregnated or saturated with a lubricant. The lubrication system 144 may simply be referred to as an oiler 144. In some embodiments, the lubricant may be a lubricating oil. In other embodiments, the lubricant may be a hydraulic fluid used in the hydraulic cylinder 112. The oiled felt 144 resides in the lubricating system cutout 146 within the retainer 122. As shown in FIG. 4, the oiled felt 144 contacts the surface 128 of the rod 126. The oiled felt 144 is located below both the wiper 130 and the seal 138. This location results in the surface 128 of the rod being lubricated by the oiled felt 144 before the rod 126 moves in an outwardly direction illustrated by arrow A. Because the exterior 128 of the rod 126 is lubricated before the exterior 128 contacts the bearing surface 142, the exterior 128 of the rod 126 is lubricated as it moves out of the hydraulic cylinder 112 along the direction illustrated by arrow A.

In particular, the surface 128 of the rod 126 that is lubricated by various embodiments in accordance with the present disclosure, is illustrated in FIG. 4. FIG. 4 is a partial cross-sectional view of the retainer 122 showing also part of the rod 126 and the hydraulic cylinder housing 113.

The embodiment shown in FIG. 4 is particularly suitable for single acting cylinders 112 where the single acting hydraulic cylinder 112 urges against a load when the rod 126 moves out of the hydraulic cylinder 112. The oiled felt 144 only applies a lubricant to the surface 128 of the rod 126 prior to the surface 128 of the rod 126 contacting the bearing surface 142 when the rod 126 is moving out of the hydraulic cylinder 112 as shown by arrow A. When such a hydraulic cylinder 112 has the rod 126 moving in towards the hydraulic cylinder 112, in the direction opposite of arrow A, then the lubricant or oil is not applied to the rod 126 prior to the rod 126 sliding along the bearing surface 142.

A dual acting hydraulic cylinder 112 experiences significant loads on the rod 126 when the rod 126 both moves out of the hydraulic cylinder 112 as indicated by arrow A and into the hydraulic cylinder 112 in a direction opposite of that shown by arrow A. Such dual acting cylinders 112 may benefit from the embodiment shown in FIG. 4. However, such hydraulic cylinders 112 will primarily only have the surface 128 of the rod 126 lubricated by the oiled felt 144 prior to the surface 128 of the rod 126 contacting the bearing surface 142 on the retainer 122 when the rod 126 is moving out of the hydraulic cylinder 112 as indicated by arrow A.

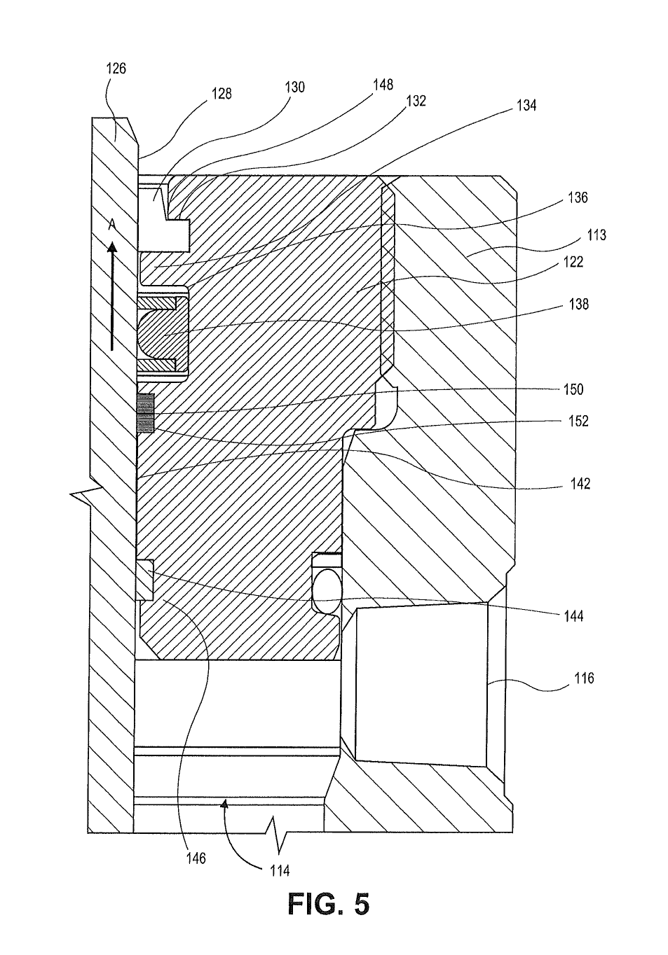

As can be appreciated by one of ordinary skill in the art, it may also be desirable to have a hydraulic cylinder assembly 111 that provides lubrication for the surface 128 of the rod 126 prior to the surface 128 of the rod 126 contacting the bearing surface 142 of the retainer 122. Such a hydraulic cylinder assembly 111 is illustrated in partial cross-section in FIG. 5.

FIG. 5 is similar to the configuration illustrated in FIG. 4. The retainer 122 is located in the housing 113 of the hydraulic cylinder 112. The inlet 116 is also shown providing access to the interior 114 of the hydraulic cylinder 112.

However, a second lubrication system which, in some embodiments, may be oiled felt 150 is located in a second lubrication groove 152 in the retainer 122 as illustrated. In the retainer 122 of the FIG. 5, a portion of the rod 126 is seen. The retainer 122 includes a wiper 130 located in the wiper recess 132 and the wiper 130 includes a stepped portion 148. The retainer 122 also includes a retaining lip 134 having a similar function as described above of retaining the seal 138 in the seal recess 136 as previously described. The retainer 122 includes a bearing surface 142. However, two lubrication systems which, in some embodiments, may include oiled felt 144 and 150 that reside in lubrication grooves 146 and 152 respectively.

As shown in FIG. 5, the lubrication system 144 is located below the bearing surface 142 in the retainer 122. Thus, as the surface 128 of the rod 126 moves out of the hydraulic cylinder 112 in the direction of arrow A, the surface 128 receives lubrication from the lubrication system 144 before contacting the bearing surface 142. In addition, the second lubrication system 150 provides lubrication to the surface 128 of the rod 126 before the surface 128 of the rod 126 rubs along the bearing surface 142 of the retainer 122 when the rod 126 moves into the hydraulic cylinder 112 in a direction opposite to that shown by arrow A. The two lubrication systems 144 and 150 are located below the bearing surface 142 and above the bearing surface 142 to provide the benefit of lubricating the surface 128 of the rod 126 prior to the surface 128 of the rod 126 rubbing against the bearing surface 142.

As can be appreciated from the discussion above, and as shown in the figures, some embodiments in the accordance of the present disclosure may include one lubrication system and others may use two. While the illustrated figures show a single lubrication system 144 located below the bearing surface 142 in other embodiments the single lubrication system may be located above the bearing surface 142 similar lubrication system 150. One of ordinary skill in the art after reviewing this disclosure may select an advantageous place to locate a lubrication system or systems for a given hydraulic cylinder.

While this disclosure has primarily discusses hydraulic cylinders, one of ordinary skill the art after reviewing this disclosure will understand that various principles of this disclosure may be applied to a variety of cylinders. For example, pneumatic cylinders, gas filled cylinders, liquid filled cylinders, or any other fluid filled cylinders that move a piston may be used in accordance with the disclosure herein. The principles described herein are not limited to hydraulic cylinders only that they are primarily discussed herein as an example.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A cylinder retainer comprising:
a retainer body having an exterior end and an interior end;
a bearing surface located on the retainer body; and
an oiler located in a recess in the retainer body.

2. The cylinder retainer of claim 1, further comprising a seal configured to reduce fluid from exiting the retainer body past the exterior end.

3. The cylinder retainer of claim 2, further comprising a seal recess in the retainer body and the seal is located in the seal recess.

4. The cylinder retainer of claim 3, wherein the bearing surface is located between the seal and the oiler.

5. The cylinder retainer of claim 1, wherein the oiler is comprises oil saturated felt.

6. The cylinder retainer of claim 1, further comprising a wiper configured to clean a surface of a cylinder rod before the cylinder rod enters the retainer.

7. The cylinder retainer of claim 1 further comprising a second oiler located in an oiler recess in the retainer.

8. The cylinder retainer of claim 1, further comprising:
a cylinder housing wherein the retainer is located at one end of the cylinder;
a rod configured to extend through the retainer body and move, at least in part, in and out of the cylinder housing;
a piston located on an end of the rod and located in the cylinder housing; and
a first inlet/outlet port located in the cylinder housing and configured to let fluid flow in and out of the cylinder housing.

9. The cylinder retainer of claim 8, further comprising a second inlet/outlet port located in the cylinder housing and configured to let fluid flow in and out of the cylinder housing wherein the first inlet/outlet port is located on one side of the piston and the second inlet/outlet port is located on a second side of the piston.

10. The cylinder retainer of claim 8, further comprising a plug located on an end of the cylinder housing opposite from the retainer.

11. The cylinder retainer of claim 8, wherein the oiler is configured to contact the rod.

12. The cylinder retainer of claim 8, wherein the seal is configured to contact the rod.

13. The cylinder retainer of claim 8, wherein the bearing surface is configured to contact the rod.

14. The cylinder retainer of claim 1, wherein oiler is generally annular in shape.

15. The cylinder retainer of claim 1, wherein body, seal, and wiper are generally annular in shape.

16. A method of lubricating a rod comprising:
contacting an oiler with the rod; and
locating a bearing surface on a retainer between a seal configured to keep fluid located on a surface of the rod in a cylinder and the oiler.

17. The method of claim 16, locating a wiper along the rod on a side of the seal opposite from the oiler.

18. The method of claim 17, further comprising: locating the oiler, wiper and seal in recesses in the retainer.

19. The method of claim 18, wherein the oiler includes felt and lubricant.

20. A cylinder retainer comprising:
a retainer body having an exterior end and an interior end;
a bearing surface located on the retainer body; and
a means for lubricating located in a recess in the retainer body.
